(19) United States
(12) Patent Application Publication
(10) Pub. No.: US 2025/0234977 A1
(43) Pub. Date: Jul. 24, 2025

(54) MODULAR ENCAPSULATION SYSTEM FOR COMBINING MULTIPLE FRAGRANCES FOR PERFUMES

(71) Applicant: NOAR BRASIL INDÚSTRIA E COMÉRCIO S.A., São Bernardo do Campo – SP (BR)

(72) Inventor: Cláudia GALVÃO, São Paulo – SP (BR)

(73) Assignee: NOAR BRASIL INDÚSTRIA E COMÉRCIO S.A., São Bernardo do Campo – SP (BR)

(21) Appl. No.: 18/698,107

(22) PCT Filed: Sep. 5, 2023
(86) PCT No.: PCT/BR2023/050294

§ 371 Date: Apr. 3, 2024

(30) Foreign Application Priority Data
Aug. 8, 2023 (BR) 10 2023 015889 7

(51) Int. Cl. A45D 34/02; A45D 34/00

(52) U.S. Cl. CPC A45D 34/02; A45D 2034/005; A45D 2200/057

(57) ABSTRACT

A modular encapsulation system for combining multiple fragrances for perfumes, especially destined to provide a customized experience to the user, enabling exclusive fragrances to be created by combining different fragrances. The modular encapsulation system can be composed of two, three, four, five or more capsules made of plastic, glass, aluminum or stainless steel. Additionally, the modular encapsulation system has a locking mechanism by rotation, further having membranes and protection membranes and aluminum seals, which guarantee the integrity of the fragrances stored in said capsules. The embodiments have their field of application in the perfumery and cosmetics sectors and customizable fragrance products.

### BRIEF PRESENTATION

The present application for patent of invention refers to a modular encapsulation system for combining multiple fragrances for perfumes and the like, which was specially developed to provide a customized experience to the user, enabling exclusive fragrances to be created by combining different fragrances. The modular encapsulation system, object of the present invention, may be comprised of two, three, four, five or more capsules made of plastic, glass, aluminum or stainless steel. Additionally, the modular encapsulation system, now claimed, has a locking mechanism by rotation, that assures the assembly and dismantling of the system in a safe manner, further having protection membranes and aluminum seals that confer the integrity of the fragrances stored in said capsules.

### FIELD OF APPLICATION

The invention that motives the present application has its field of application focused towards the perfumery and cosmetics industry, more specifically, customizable fragrance products.

### Problem to be Solved

Today, there is a trend in the perfumery and cosmetics industry to offer consumers the possibility of creating their own fragrances. As an illustration, it is possible to cite the use of “do it yourself” perfume kits, which require the user to manually mix different essential oils and other ingredients to form a customized fragrance. Although these perfume kits enable a some measure of customization, they still present some drawbacks, such as, for example, the fact of requiring the consumer to have a certain degree of knowledge and skill in correctly combining the ingredients, making the process complex and costly for inexperienced users. Additionally, the manual mixture may lead to inconsistent results, since it is difficult to exactly replicate the same proportion of ingredients, each time the fragrance is crafted. Nevertheless, the manual mixture process may lead to the contamination of the ingredients, compromising the quality of the fragrance obtained.

Another concept known on the market, is the “create your own perfume”, where consumers can visit the perfumery laboratory and work with a perfume maker to create a customized fragrance. Although this concept may offer much personalization, it is a costly and lengthy process, making it inaccessible for many consumers. Even so, it is a concept that requires the physical presence of the consumer at the perfume laboratory.

### CURRENT STATE OF THE ART

The current state of the art contains the document US 20100252573, published on Oct. 7, 2010, which relates to describing a bottle of interchangeable perfume composed of an outer casing and an inner casing, both transparent, wherein the inner casing, filled with perfume, has a channel that is is sealed by a spray head. Further, the said casing is kept in place by pins, being visible by means of windows in the outer casing. After using it, the inner casing can be replaced for another one, enabling the exchange of the perfume and the continuous use of the bottle.

In short, the prior art is cited because it is the closest state-of-the-art to the present invention. However, the prior art does not have teachings consistent with the subject matter now claimed, in the present patent application.

### BRIEF DESCRIPTION OF THE INVENTION

The present application for patent of invention refers to an innovative solution for creating and personalizing fragrances by means of a modular encapsulation system. The modular encapsulation system of the present invention proposes a structure divided into two, three, four, five or more parts, and in a preferred embodiment, it can be assembled by means of one top capsule, one mid and one bottom capsule. In particular, each of these capsules can be filled with a fragrance different, thus enabling a customized perfume to be created by combining different essences. However, the mixture of the fragrances only occurs when a valve with a tube is inserted into the modular encapsulation system, wherein the tube breaks the membranes sealing each one of the capsules in order to release the fragrances into the mixture. Additionally, aluminum seals are incorporated into the capsules to enhance the safety and prevent contamination and unwanted manipulation. In short, the present invention provides users the opportunity to create their own fragrances in a unique and personalized manner, and with safety.

### Advantages of the Invention

The present invention has the following advantages:
It provides the user the capacity to personalize the fragrance of a perfume according or his or her individual preferences, enabling hyper-personalization in the perfumery sector;
It uses a modular encapsulation system, assuring the separation and protection of each fragrance individually, thus upholding the integrity of the components and preventing contamination;
The modular encapsulation system can operate with two, three, four, five or more capsules, providing additional flexibility in customizing and allowing the user to create even more fragrance combinations;
, It includes locking mechanisms by rotation that enable safe and efficient assembly and dismantling of the capsules;
It incorporates membranes in the capsules which when broken by tube when a valve spray is inserted, enabling the fragrances to be mixed in a controlled way at the time of use, assuring the freshness of the components;
It has aluminum seals to assure even more protection and safety against manipulation of the capsules, before the system is assembled by the consumer;
, It offers the consumer the unique experience of creating his or her own fragrance without the need of a perfume maker or perfumery laboratory;
The modular construction enables capsules to be easily replaced or exchanged, potentially enhancing the versatility and increasing the useful life of the product;
The capsules can be made of different materials, including plastic, glass, aluminum or stainless steel, providing flexibility in production and potentially influencing the appearance, weight and durability of the product;
The system modular may also facilitate the logistics and the transport of the individual components, potentially reducing the shipping and storage costs;
The modular encapsulation system enables consumers to personalize their own fragrance without the need of acquiring various different perfumes, resulting in significant savings for the consumer, who may obtain a variety of fragrances in a single product, dispensing the need to purchase various bottles of perfume to obtain the same variety of fragrances;
And it enables perfume companies to offer a broad variety of fragrances in a hyper-personalizable manner.

### DESCRIPTION OF THE DRAWINGS

In order to assist with understanding, the following figures are appended:

FIG. 1: shows a perspective view of the modular encapsulation system for combining multiple fragrances for perfumes;

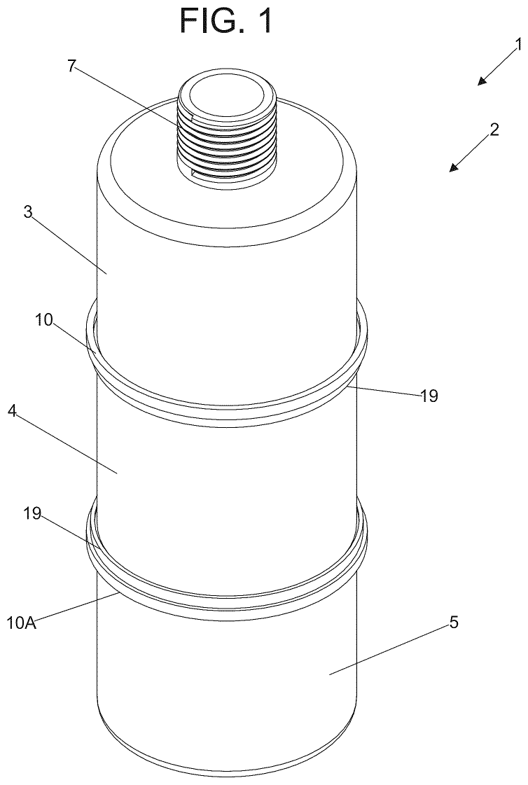

FIG. 2: shows a blown-up perspective view of the modular encapsulation system for combining multiple fragrances for perfumes;

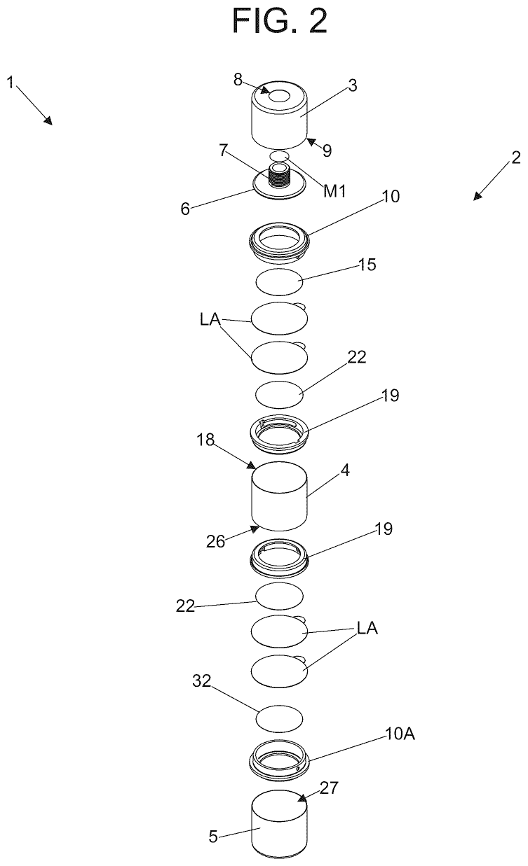

FIG. 3: shows a perspective cutaway view of the modular encapsulation system for combining multiple fragrances for perfumes, showing the locking mechanism by rotation;

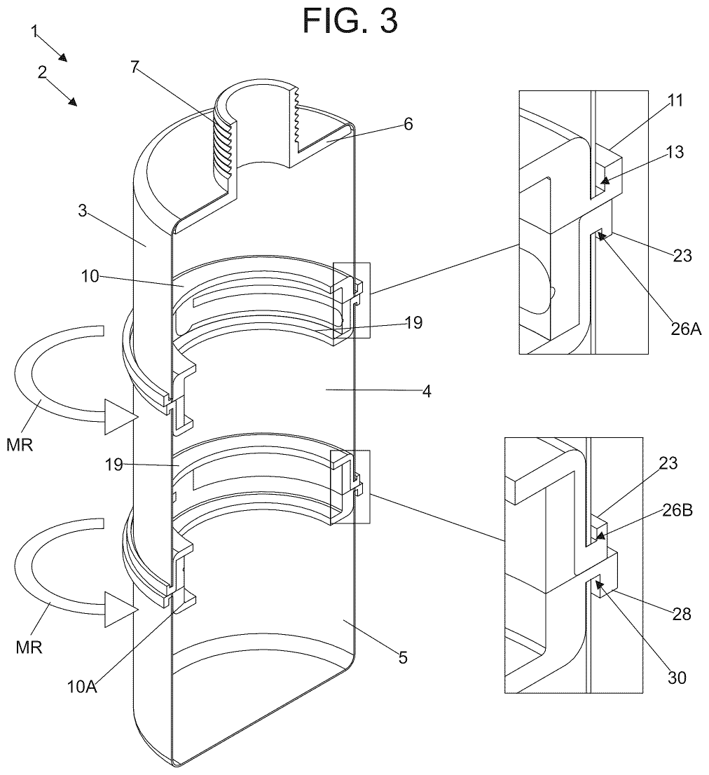

FIG. 4: shows a perspective cutaway view of the modular encapsulation system for combining multiple fragrances for perfumes;

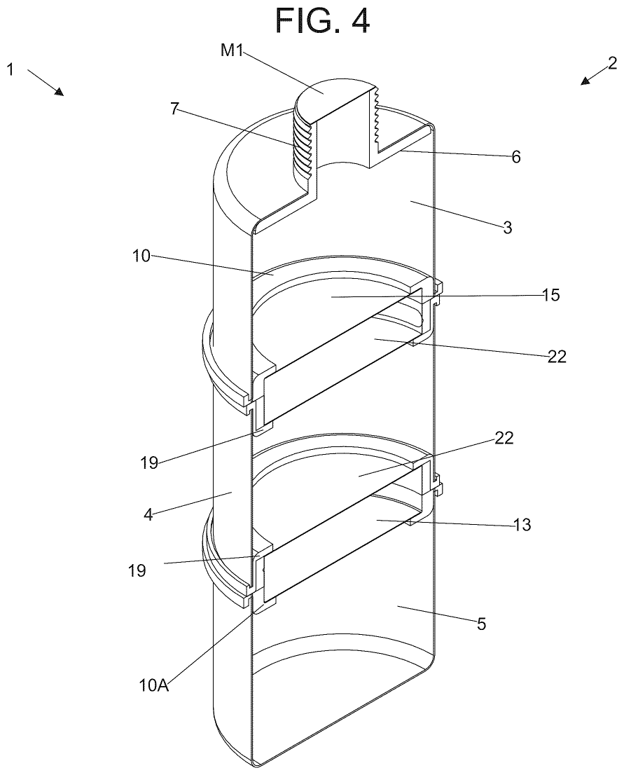

FIG. 5: shows a perspective view of the connectors of the modular encapsulation system;

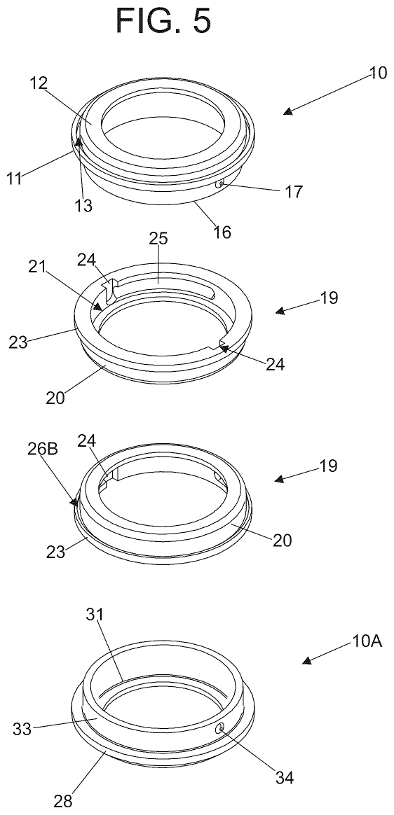

FIG. 6: shows an upside down perspective view of the connectors of the modular encapsulation system;

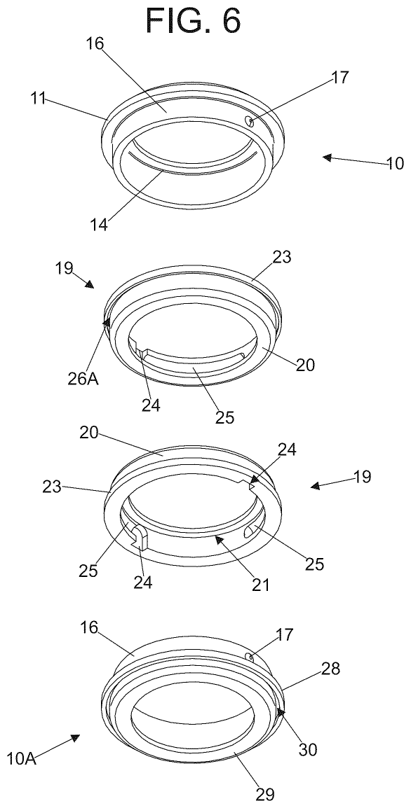

FIG. 7: shows a perspective cutaway view of the modular encapsulation system for combining multiple fragrances for perfumes, showing the tube of the valve breaking the first membranes;

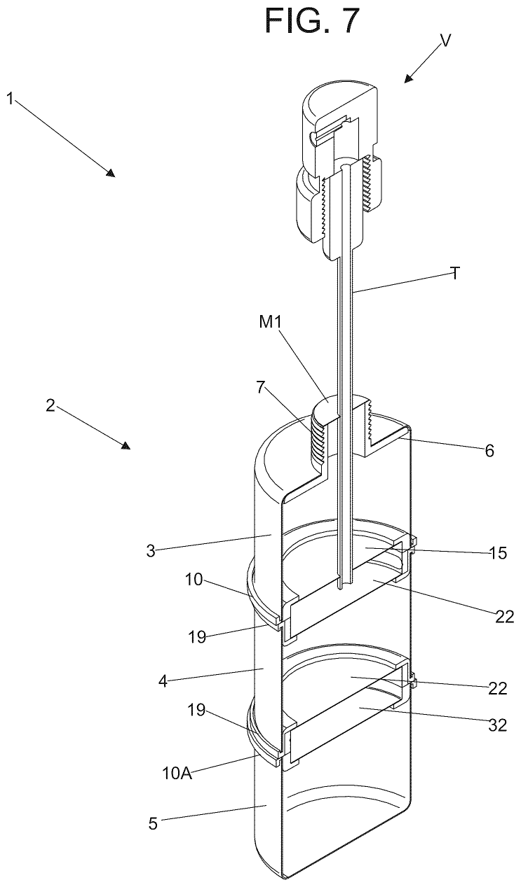

FIG. 8: shows a perspective cutaway view of the modular encapsulation system for combining multiple fragrances for perfumes, showing the tube of the valve breaking the first membranes and the mid membranes;

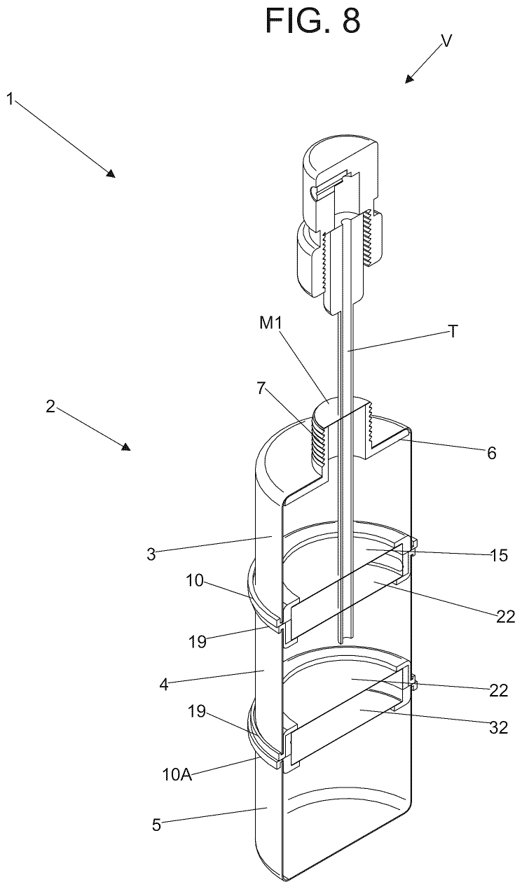

FIG. 9: shows a perspective cutaway view of the modular encapsulation system for combining multiple fragrances for perfumes, showing the tube of the valve breaking all the membranes;

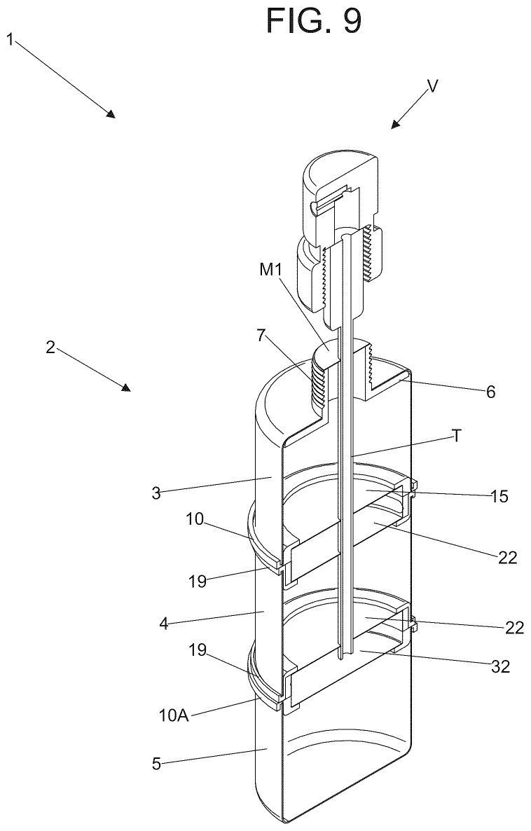

FIG. 10: shows a perspective cutaway view of the modular encapsulation system for combining multiple fragrances for perfumes, showing the system ready for use;

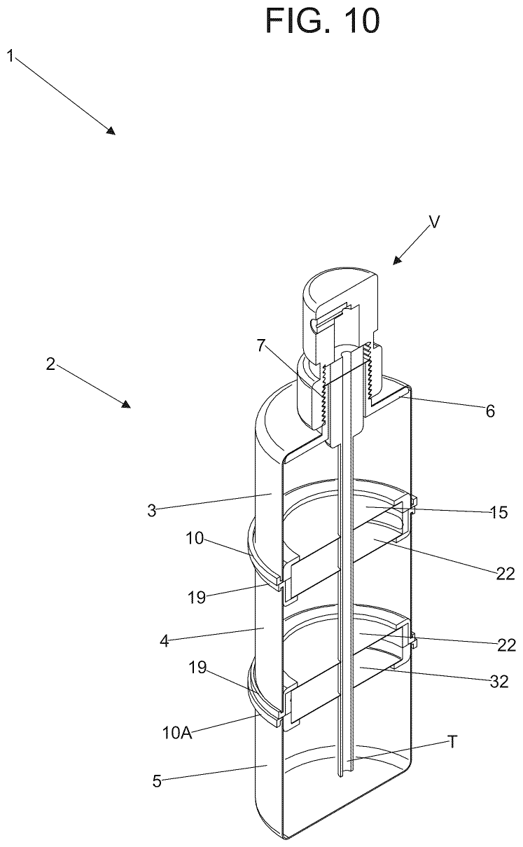

FIG. 11: shows a perspective view of the modular encapsulation system for combining multiple fragrances for perfumes, showing the system surrounded by an outer bottle.

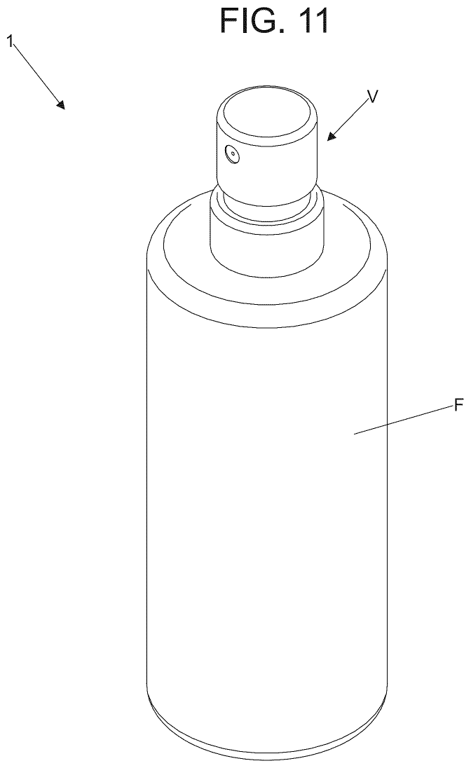

### DETAILED DESCRIPTION OF THE INVENTION

The MODULAR ENCAPSULATION SYSTEM FOR COMBINING MULTIPLE FRAGRANCES FOR PERFUMES object of this application for patent of invention, consists in providing consumers and appreciators of perfumes, a set of capsules (1) incorporated by a modular encapsulation system (2), which is to enable the hyper customization for the perfumery segment, enabling each consumer to have a unique experience in creating his or her own fragrance, as well as being able to personalize an outer bottle (F), which coats said modular encapsulation system (2) with diverse labels.

More particularly, the present invention consists of a modular encapsulation system (2), object of the present invention, which is formed by a connector (19), connectors (22) and a connector (10A), whereas the connector (10) is inserted into a top capsule (3), the connectors (22) inserted into a mid capsule (4) and the connector (10A) inserted into a bottom capsule (5), which are made of plastic, glass, aluminum or stainless steel. Specially, the top capsule (3) is equipped with a top cylindrical base (6) incorporated by a threaded neck (7), which traverses the top central hole (8) of the top capsule (3), also having a membrane (M1). The top capsule (3) has a bottom hollow nozzle (9), which receives a connector (10), being comprised by a greater diameter outer circular base (11), which is interconnected with a rising central body (12), completing a circular perimeter recess (13). The rising central body (12) has an internal seat (14), which has the function of housing a membrane (15). Further, the connector (10) comprises a bottom projected cylindrical body (16) endowed with fitting beads (17). Therefore, the connector (10) is employed on the bottom hollow nozzle (9) of the top capsule (3) by means of the circular perimeter recess (13).

The mid capsule (4), in turn, is comprised of a top hollow nozzle (18), which receives the fitting of a connector (19) from top to bottom, wherein the connector (19) is endowed with a projected cylindrical body (20), being equipped with an internal seat (21) to house a membrane (22). The projected cylindrical body (20) is interconnected with a larger diameter cylindrical base (23) endowed with internal recesses (24), which are interconnected on extended channels (25), further having a circular perimeter recess (26A) for fitting into the top hollow nozzle (18) of the mid capsule (4). The mid capsule (4) also has a bottom hollow nozzle (26), which also receives the connector (19), but this time, upside down, that is, the connector (19) is fitted into the bottom hollow nozzle (26) of the mid capsule (4) from bottom to top, by means of circular perimeter recess (26B), having an internal seat (21) to house a second membrane (22).

The bottom capsule (5) comprises a top hollow nozzle (27), which receives the fitting of the connector (10A) comprised of a greater diameter outer circular base (28), which is interconnected with a rising central body (29), completing a circular perimeter recess (30). The rising central body (29) has an internal seat (31) to house a membrane (32). Further, the connector (10A) comprises a bottom projected cylindrical body (33) endowed with fitting beads (34). Therefore, the connector (10A) is fitted into the top hollow nozzle (27) of the bottom capsule (5) by means of the circular perimeter recess (30).

It is important to point out that the membrane (15) accommodated on the internal seat (14) of the connector (10) of the top capsule (3), the membranes (22) housed on the internal seats (21) of the connector (19) of the mid capsule (4) and of the membrane (32) housed on the internal seat (31) of the connector (10A) of the bottom capsule (5), allow no type of handling of the fragrances incorporated both in the top capsule (3), in the mid capsule (4), as in the bottom capsule (5), comply with all regulatory requirements of the sector.

Moreover, in order to increase the safety of the modular encapsulation system (2), there is the application of aluminum seals (LA), which are applied between the connector (10) and the connector (19), as well as the connector (19) and the connector (10A), which increase the safety and handling protection of both capsules. However, said aluminum seals (LA) are withdrawn by the consumer before the modular encapsulation system (2) is assembled.

Another differentiating aspect of the present invention is that the modular encapsulation system (2) has a locking mechanism by rotation (MR), which enables the top capsule (3) to be interlocked in the mid capsule (4), and the bottom capsule (5) to be interlocked in the mid capsule (4). By way of example, the locking mechanism by rotation (MR) occurs when the top capsule (3) is inserted into the mid capsule (4), more precisely, by means of the fitting beads (17) situated in the bottom projected cylindrical body (16) of the connector (10), which enter into the recesses (24) of the larger diameter cylindrical base (23) of the connector (19). Then, by means of the locking mechanism by rotation (MR), the top capsule (3) is rotated against the mid capsule (4), or vice-versa, meaning the fitting beads (17) access the extended channels (25) interconnected with the recesses (24) per se, whereupon the locking occurs between both the top capsule (3) and the mid capsule (4).

The same occurs between the bottom capsule (5) and the mid capsule (4), that is, the bottom capsule (5) is interlocked in the mid capsule (4) by the locking mechanism by rotation (MR), where the fitting beads (34) of the bottom projected cylindrical body (33) of the connector (10A), access the recesses (24) of the larger diameter cylindrical base (23) of the connector (19). The, by means of the locking mechanism by rotation (MR), the bottom capsule (5) is rotated against the mid capsule (4), or vice-versa, meaning the fitting beads (34) access the extended channels (25) interconnected to the recesses (24) per se, whereupon locking occurs between the bottom capsule (5) and the mid capsule (4).

In terms of operating the modular encapsulation system (2), the user inserts a valve (V) equipped with a tube (T) into the threaded neck (7) of the top cylindrical base (6) of the top capsule (3), whereas the tube (T) breaks the membrane (15) of the top capsule (3), and the membranes (22) of the mid capsule (4) and the membrane (32) of the bottom capsule (5), thus causing the fragrances to mix, since the top capsule (3) may store a fragrance “X”, the mid capsule (4) a fragrance “Y” and the bottom capsule (5) a fragrance “Z”.

Nevertheless, the modular encapsulation system (2) may be by means of a top capsule (3), two, four, five or more mid capsules (4) and, a bottom capsule (5), that is, the modular encapsulation system (2) enables a vast gamut of quantity of capsules to be assembled.

It must be highlighted that in the present invention fragrances are obtained in a highly safe manner, that is, there is no risk of contamination of the fragrances, because the modular encapsulation system (2), now claimed, is comprised of said membranes (15), (22) and (32). Furthermore, the consumer will not need a perfume maker to prepare his or her fragrance in a perfumery laboratory, for example.

In synthesis, the modular encapsulation system (2), object of the present invention, enables the hyper customization of the perfume industry, in addition to allowing each consumer to have a unique experience in creating his or her own fragrance.

1-7. (canceled)

8. A modular encapsulation system for combining multiple fragrances for perfumes, comprising:
a set of capsules that actuates with a valve endowed with a tube, inserted into a threaded neck for perfumes, and
an outer bottle, wherein the set of capsules has a modular encapsulation system formed by a top cylindrical base incorporated into a top capsule, wherein the cylindrical base comprises a threaded neck that passes through the central hole of the top capsule being covered by a membrane; by having a connector inserted into the bottom hollow nozzle of the top capsule, whose connector presents a greater diameter outer circular base, which interconnects with a rising central body, completing a circular perimeter recess; by the rising central body having an internal seat that accommodates a membrane; by the connector being equipped with a bottom projected cylindrical body endowed with fitting beads; further, by the modular encapsulation system comprising a connector, which has a projected cylindrical body equipped with an internal seat to house a membrane; by the projected cylindrical body being connected on a larger diameter cylindrical base endowed with internal recesses, which are interconnected on extended channels; by the mid capsule presenting a bottom hollow nozzle, which receives the connector from bottom to top; by the modular encapsulation system also having a connector which is inserted into the top hollow nozzle of a bottom capsule, wherein the connector is comprised of a greater diameter outer circular base, which is interconnected on a rising central body, completing a circular perimeter recess; by the rising central body comprising an internal seat to house a membrane; by the connector presenting a bottom projected cylindrical body endowed with fitting beads; further, by the connector, the connectors and the connector of the modular encapsulation system forming a locking mechanism by rotation, which enables the top capsule to be interlocked in the mid capsule, and the bottom capsule to be interlocked in the mid capsule; by the modular encapsulation system having aluminum seals, applied between the connector and the top capsule and, between the connector of the mid capsule, as well as between the lower connector of the mid capsule and the connector of the bottom capsule.

9. The modular encapsulation system for combining multiple fragrances for perfumes according to claim 8, wherein the connector is employed on the bottom hollow nozzle of the top capsule by the circular perimeter recess; by the connector being fitted into the top hollow nozzle (of the mid capsule by a circular perimeter recess and, being fitted into the bottom hollow nozzle by circular perimeter recess; by the connector being fitted into the top hollow nozzle of the bottom capsule by the circular perimeter recess.

10. The modular encapsulation system for combining multiple fragrances for perfumes according to claim 8, wherein the membrane is accommodated on the internal seat of the connector of the top capsule; by the membrane being housed on the internal seat of the connector of the mid capsule; by the membrane being accommodated on the internal seat of the connector of the bottom capsule and; allow no type of handling of the fragrances incorporated in the top capsule, in the mid capsule and in the bottom capsule.

11. The modular encapsulation system for combining multiple fragrances for perfumes according to claim 8, wherein the locking mechanism by rotation actuating by the top capsule is inserted into the mid capsule, by the fitting beads situated on the bottom projected cylindrical body of the connector, which enter into the recesses of the larger diameter cylindrical base of the connector; further, by the locking mechanism by rotation enabling the top capsule to be rotated against the mid capsule, or vice-versa, meaning that the fitting beads access the extended channels interconnected to the recesses, whereupon locking occurs between the top capsule and the mid capsule.

12. The modular encapsulation system for combining multiple fragrances for perfumes according to claim 8, wherein the locking mechanism by rotation actuating by the bottom capsule is inserted into the mid capsule, where the fitting beads of the bottom projected cylindrical body of the connector, access the recesses of the larger diameter cylindrical base of the connector; further, by the locking mechanism by rotation enabling the bottom capsule to be rotated against the mid capsule, or vice-versa, meaning that the fitting beads access the extended channels interconnected to the recesses of the connector, whereupon locking occurs between the bottom capsule and the mid capsule.

13. The modular encapsulation system for combining multiple fragrances for perfumes according to claim 8, wherein the threaded neck of the top cylindrical base inserted into the top capsule is incorporated by a valve endowed with a tube, wherein the tube breaks the membrane of the top capsule, the two membranes of the mid capsule and the membrane of the bottom capsule, in a controlled manner, to cause the mixture of the fragrances to configure a perfume; since the top capsule may store a fragrance “X”, the mid capsule a fragrance “Y” and the bottom capsule a fragrance “Z”.

14. The modular encapsulation system for combining multiple fragrances for perfumes according to claim 8, wherein the modular encapsulation system is configured by means of a top capsule, two, four, five or more mid capsules and a bottom capsule.
